(19) United States
(12) Patent Application Publication
(10) Pub. No.: US 2014/0167915 A1
(43) Pub. Date: Jun. 19, 2014

(54) LOCK DEVICE, LOCK DEVICE CONTROLLER, AND ELECTRIC KEY SYSTEM

(71) Applicants: TOYOTA JIDOSHA KABUSHIKI KAISHA, Aichi-ken (JP); KABUSHIKI KAISHA TOKAI RIKA DENKI SEISAKUSHO, Aichi (JP)

(72) Inventors: Kensuke TAMADA, Aichi (JP); Akihito KIMURA, Aichi (JP); Tadayuki TOBIMATSU, Aichi (JP); Keiji YAMAMOTO, Aichi (JP); Takashi IEDA, Aichi (JP); Koichi KOJIMA, Toyota-shi (JP)

(73) Assignees: TOYOTA JIDOSHA KABUSHIKI KAISHA, Aichi-ken (JP); KABUSHIKI KAISHA TOKAI RIKA DENKI SEISAKUSHO, Aichi (JP)

(21) Appl. No.: 14/103,205

(22) Filed: Dec. 11, 2013

(30) Foreign Application Priority Data
Dec. 13, 2012 (JP) 2012-272505

(51) Int. Cl. G07C 9/00

(52) U.S. Cl. CPC G07C 9/00174
USPC 340/5.61

(57) ABSTRACT

A lock device locks a locking subject to restrict removal of a charge cable from a power port of a vehicle or restrict access of the charge cable to the power port). The lock device includes a verification request unit that requests for wireless communication verification including vehicle interior verification to be executed on an electronic key when detecting an event that initiates the wireless communication verification. A control unit controls at least one of locking and unlocking of the locking subject based on a result of the wireless communication verification.

### CROSS-REFERENCE TO RELATED APPLICATIONS

This application is based upon and claims the benefit of priority from prior Japanese Patent Application No. 2012-272505, filed on Dec. 13, 2012, the entire contents of which are incorporated herein by reference.

### BACKGROUND

The present invention relates to a lock device for locking a locking subject.

A vehicle that emits less carbon dioxide, such as a plugin hybrid vehicle and an electric vehicle, includes a battery and a power port. The battery drives a motor that drives the vehicle, and the power port is used to charge the battery. The user connects a charge cable, which extends from a charging facility, to the power port to charge the battery with the power supplied from the charging facility. A charge cable lock device may be used to lock the charge cable when charging the battery and prevent theft of the charge cable. Japanese Laid-Open Patent Publication No. 2009-081917 describes an example of such a charge cable lock device.

### SUMMARY

To improve the charge cable lock device, the inventors of the present invention have studied a lock device of a referential example that incorporates ID verification (smart verification) executed on an electronic key. The lock device of the referential example is activated upon accomplishment of the electronic key ID verification (smart verification), which is initiated by radio waves transmitted from a transmission antenna arranged in the power port. However, in the referential example, when the user attempts to unlock the charge cable after entering the vehicle, the user has to temporarily exit the vehicle and hold the electronic key near the power port. This is inconvenient for the user.

It is an object of the present invention to provide a lock device that improves convenience.

One aspect of the present invention is a lock device that locks a locking subject to restrict removal of a charge cable from a power port of a vehicle or restrict access of the charge cable to the power port. The lock device includes a verification request unit that requests for wireless communication verification including vehicle interior verification to be executed on an electronic key when the verification request unit detects an event that initiates the wireless communication verification. A control unit controls at least one of locking and unlocking of the locking subject based on a result of the wireless communication verification.

Another aspect of the present invention is a lock device controller that controls a movable lock member for locking a locking subject to restrict removal of a charge cable from a power port of a vehicle or restrict access of the charge cable to the power port. The movable lock member is movable between a lock position where the lock member locks the locking subject and an unlock position where the lock member unlocks the locking subject. The lock device controller includes a verification request unit that requests for wireless communication verification including vehicle interior verification to be executed on an electronic key when detecting an event that initiates locking or unlocking of the locking subject; and a control unit that controls the movable lock member based on a result of the wireless communication verification.

Further aspect of the present invention is an electronic key system including an electronic key that performs wireless communication, a verification ECU that performs wireless communication verification on the electronic key, and a lock device that locks a locking subject to restrict removal of a charge cable from a power port of a vehicle or restrict access of the charge cable to the power port. The lock device includes a movable lock member that is movable between a lock position where the lock member locks the locking subject and an unlock position where the lock member unlocks the locking subject. An event sensor detects an event for requesting the locking subject to be unlocked. A controller that receives a detection result from the event sensor and controls the movement of the movable lock member. The controller is configured to: request the verification ECU to execute wireless communication verification including vehicle interior verification on the electronic key when the event sensor detects the event; and move the movable lock member to the unlock position when the vehicle interior verification, which is executed after the event is detected, is accomplished. In one embodiment, the verification ECU is configured to first execute, when receiving the request for execution of the wireless communication verification, vehicle exterior verification in an exterior power port communication area formed around the power port, and then execute the vehicle interior verification in the vehicle if the vehicle exterior verification is unaccomplished.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of a vehicle including one embodiment of a lock device;

FIG. 2 is a perspective view of a power port and a charge cable;

FIGS. 3A to 3C are schematic diagrams showing the operation of the lock device when locking the charge cable;

FIGS. 4A to 4D are schematic diagrams showing the operation of the lock device when unlocking the charge cable;

FIG. 5A is a schematic diagram showing a lid when unlocked by a lock device of a further example; and

FIG. 5B is a schematic diagram showing the lid when locked by the lock device of the further example.

### DESCRIPTION OF EMBODIMENTS

One embodiment of a lock device will now be described.

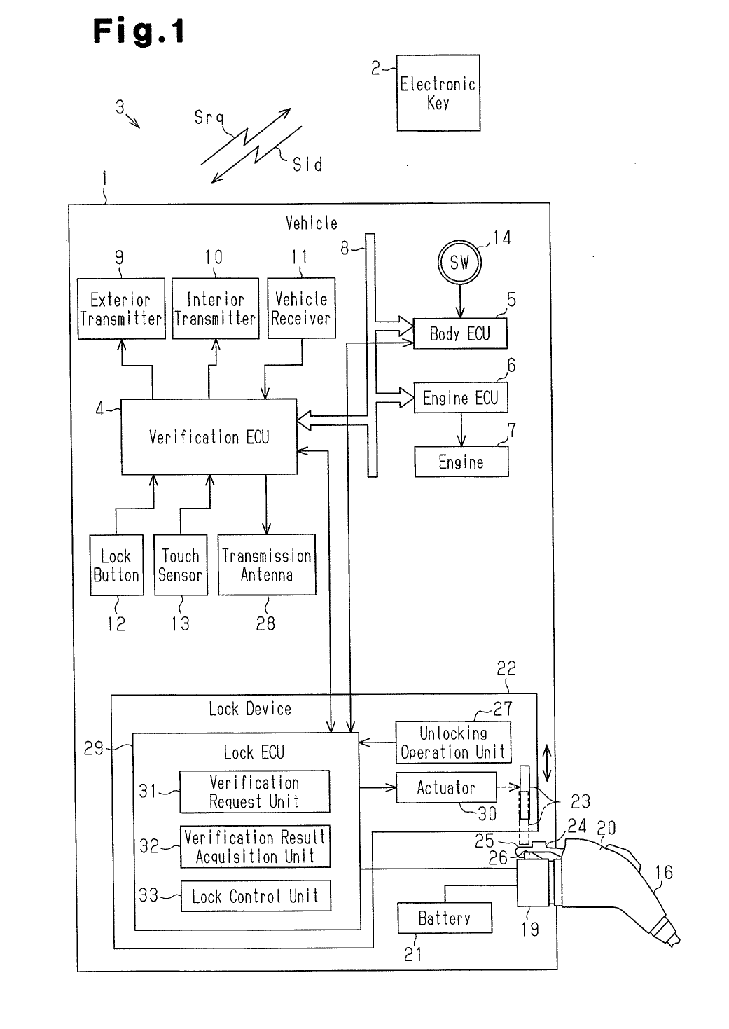

Referring to FIG. 1, a vehicle 1 includes an electronic key system 3 that performs wireless communication with an electronic key 2, which has an electronic key ID, to execute electronic key verification. The electronic key system 3 is, for example, an operation-free key system that executes ID verification (smart verification) by performing short-range wireless communication (communication distance of several meters), which is initiated by the vehicle 1. The electronic key 2 may be referred to as a remote control key device capable of transmitting the electronic key ID through wireless communication.

The vehicle 1 includes a verification electronic control unit (ECU) 4 that verifies the electronic key ID, a body ECU 5 that manages the power supplied to on-board electric devices, and an engine ECU 6 that controls the engine 7. An in-vehicle bus 8 connects the ECUs 4, 5, and 6. The verification ECU 4 includes a memory that stores the electronic key ID of the electronic key 2 that is registered to the vehicle 1. The verification ECU 4 is connected to an exterior transmitter 9, which transmits radio waves on the low frequency (LF) band out of the vehicle 1, an interior transmitter 10, which transmits radio waves on the LF band in the vehicle 1, and a vehicle receiver 11, which receives radio waves on the ultrahigh frequency (UHF) band.

When the vehicle 1 is parked or stopped, the exterior transmitter 9 transmits, through wireless communication, a request signal Srq out of the vehicle 1 to request for an ID reply. The electronic key 2 that receives the request signal Srq returns, through wireless communication, an ID signal Sid. The request signal Srq is, for example, a wireless signal on the LF band, and the ID signal Sid is, for example, a wireless signal on the UHF band. The ID signal Sid includes the electronic key ID, which is unique to the electronic key 2. When the verification ECU 4 receives the ID signal Sid with the vehicle receiver 11, the verification ECU 4 executes ID verification (vehicle exterior smart verification) on the electronic key ID in the ID signal Sid. When accomplishing the verification, the verification ECU 4 permits or performs the locking or unlocking of a vehicle door. For example, if the door is unlocked and a lock button 12 on an outer door handle is manually operated, the vehicle door is locked when vehicle exterior smart verification is accomplished. If the door is locked and a touch sensor 13 on the outer door handle is touched, the vehicle door is unlocked when vehicle exterior smart verification is accomplished. The vehicle exterior smart verification may simply be referred to as the vehicle exterior verification.

When the electronic key 2 is located in the vehicle 1, the interior transmitter 10 transmits a request signal Srq inside the vehicle 1. Then, ID verification (vehicle interior smart verification) is executed through the same procedures as the vehicle exterior smart verification. When vehicle interior smart verification is accomplished and an engine switch 14 arranged near the driver seat is manually operated, power activation (engine starting) of the vehicle 1 is permitted. The vehicle interior smart verification may simply be referred to as the vehicle interior verification.

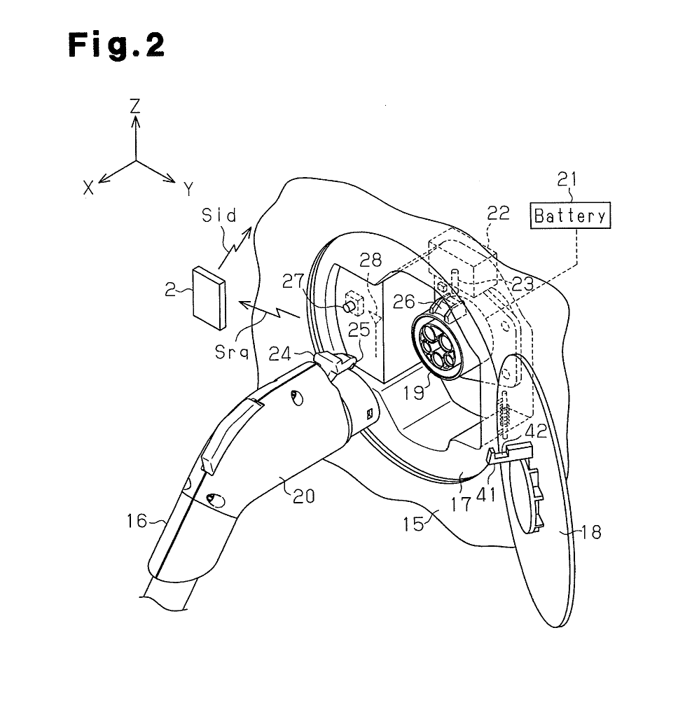

Referring to FIG. 2, the vehicle 1 includes a battery 21 for a plugin hybrid vehicle or an electric vehicle. The vehicle body 15 includes a power port 17 arranged in, for example, a side wall. A lid 18 closes the power port 17. An inlet 19, which includes a power reception connection terminal, is arranged in the inlet 19. A power plug 20, which includes a power supplying connection terminal, is arranged on the distal end of the charge cable 16. The power plug 20 is connected to the inlet 19 to charge the battery 21. The charge cable 16 or the lid 18 is an example of a locking subject.

The power port 17 includes a lock device 22 (also referred to as the charge cable lock device) that restricts removal of the charge cable 16 from the inlet 19. The lock device 22 includes a lock pin 23 moved to an unlock position and a lock position. In one example, the lock pin 23 is an elongated member that is moved straight back and forth along the Z axis as viewed in FIG. 2. When the charge cable 16 is connected to the inlet 19, an urging member (not shown) pivots a lock arm 24 of the power plug 20 to a close position. A hook 25 on the distal end of the lock arm 24 is hooked to a catch 26 on the inlet 19 so that the charge cable 16 cannot be separated from the inlet 19. The lock device 22 locks the charge cable 16 to the inlet 19 by holding the hook 25 of the lock arm 24 from above with the lock pin 23 that is located at a lock position. The lock pin 23 is one example of a lock member.

The power port 17 includes an unlocking operation unit 27 manually operated to unlock the charge cable 16. In the illustrated example, the unlocking operation unit 27 is a push type momentary switch.

A transmission antenna 28 transmits radio waves to an exterior power port communication area CA1 formed near the power port 17 so that the verification ECU 4 of the electronic key system 3 can execute electronic key verification. For example, the transmission antenna 28 transmits a request signal Srq to the exterior power port communication area CA1. The transmission of the request signal initiates smart verification that checks whether or not the electronic key 2 located in the exterior power port communication area CA1 is authorized. The request signal Srq may be a wireless signal in the LF band. When the lock ECU 29 detects operation of the unlocking operation unit 27 as an unlocking request event, the lock ECU 29 requests for the transmission of a request signal Srq to the verification ECU 4, that is, the initiation of wireless communication verification of the electronic key 2. The verification ECU 4 manages the transmission of wireless communication signals from the transmission antenna 28. The accomplishment of smart verification in the exterior power port communication area CA1 is one condition for permitting the unlocking of the charge cable 16. The unlocking request event is one example of a smart verification initiation event.

Referring to FIG. 1, electric wires connect the lock ECU 29 of the charge cable lock device 22 to the verification ECU 4, the body ECU 5, and the unlocking operation unit 27. Further, the lock ECU 29 provides the actuator 30 with a drive signal. The actuator 30 moves the lock pin 23 to the lock position and the unlock position in accordance with the drive signal from the lock ECU 29. The lock pin 23 and the actuator 30, which is a drive source of the lock pin 23, form one example of a lock mechanism.

In some embodiments, the lock ECU 29 may detect the connection of the charge cable 16 to the inlet 19 as a locking request event, and the lock ECU 29 may request the verification ECU 4 to initiate smart verification in the exterior power port communication area CA1 in response to the locking request event. The locking request event is one example of a smart verification initiation event.

The lock ECU 29 includes a verification request unit 31, a verification result acquisition unit 32, and a lock control unit 33. The verification request unit 31 requests the verification ECU 4 to initiate smart verification in response to a smart verification initiation event (locking request event, unlocking request event). The verification result acquisition unit 32 acquires the smart verification result from the verification ECU 4. The lock control unit 33 controls the operation of the lock mechanism based on the acquired smart verification result. An example of an unlocking request event is an ON signal output from the unlocking operation unit 27 when the unlocking operation unit 27 is manually operated. The verification result acquisition unit 32 and the lock control unit 33 function as a control unit.

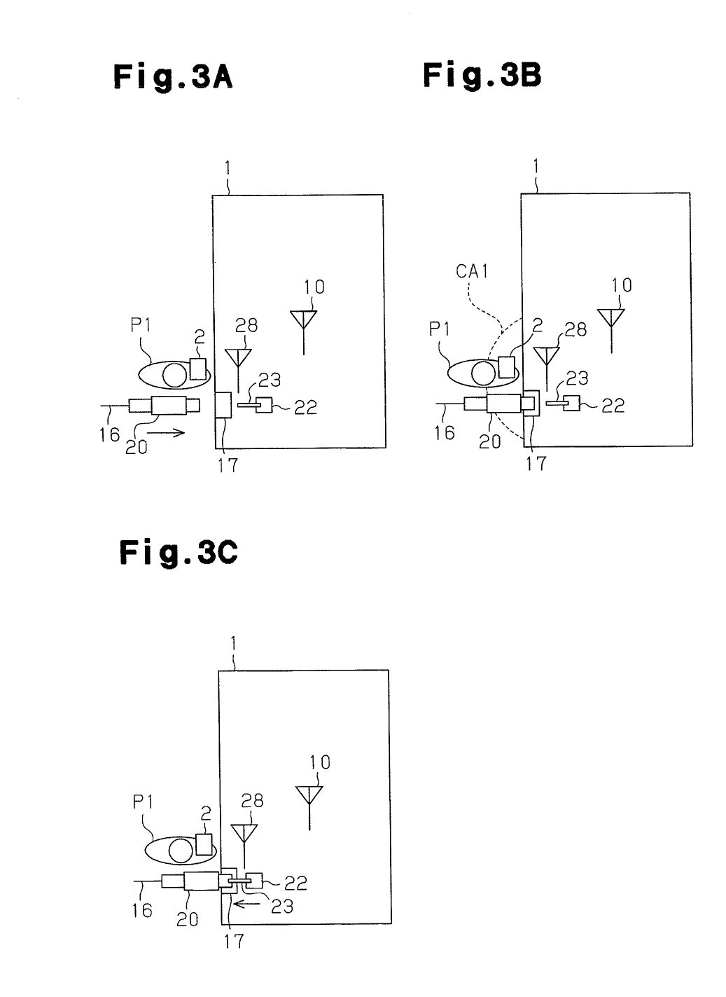

The operation of the lock device 22 when locking the charge cable 16 will now be described with reference to FIGS. 3A to 3C.

FIG. 3A shows an example in which a person P1 is carrying the electronic key 2 outside the vehicle 1. Here, the charge cable 16 is not connected to the power port 17. Thus, the verification request unit 31 does not detect a locking initiation event, and the transmission antenna 28 does not transmit a request signal Srq to the verification power port communication area CA1.

Then, referring to FIG. 3B, the person P1 carrying the electronic key 2 connects the charge cable 16 to the power port 17. Here, the verification request unit 31 detects a locking initiation event and provides the verification ECU 4 with a smart verification initiation request. In response to the smart verification initiation request from the verification request unit 31, the verification ECU 4 transmits a request signal Srq to the exterior power port communication area CA1 and executes smart verification in the exterior power port communication area CA1. When the person P1 carrying the electronic key 2 connects the charge cable 16 to the inlet 19, smart verification is accomplished in the exterior power port communication area CA1. The verification ECU 4 provides the lock ECU 29 with a smart verification accomplishment notification when smart verification is accomplished in the exterior power port communication area CA1. The verification result acquisition unit 32 of the lock ECU 29 acquires the smart verification accomplishment notification.

Referring to FIG. 3C, when the lock control unit 33 receives the smart verification accomplishment notification after detecting the locking request event, the lock control unit 33 provides the actuator 30 with a lock drive signal and moves the lock pin 23 from the unlock position to the lock position. When the lock pin 23 comes into contact with the lock arm 24 of the charge cable 16 connected to the inlet 19, the charge cable 16 is locked. This restricts unauthorized removal of the charge cable 16 from the inlet 19 by an unauthorized person.

In the illustrated example, the locking request event is the connection of the charge cable 16 to the inlet 19. However, the locking request event is not limited in such a manner. For example, the locking request event may be the connection of the charge cable 16 to the inlet 19 and a subsequently performed operation of a lock switch or button arranged in the power port 17 or near the driver seat. In a further example, the lock request event may be the connection of the charge cable 16 to the inlet 19 and a subsequently performed operation for locking the vehicle door.

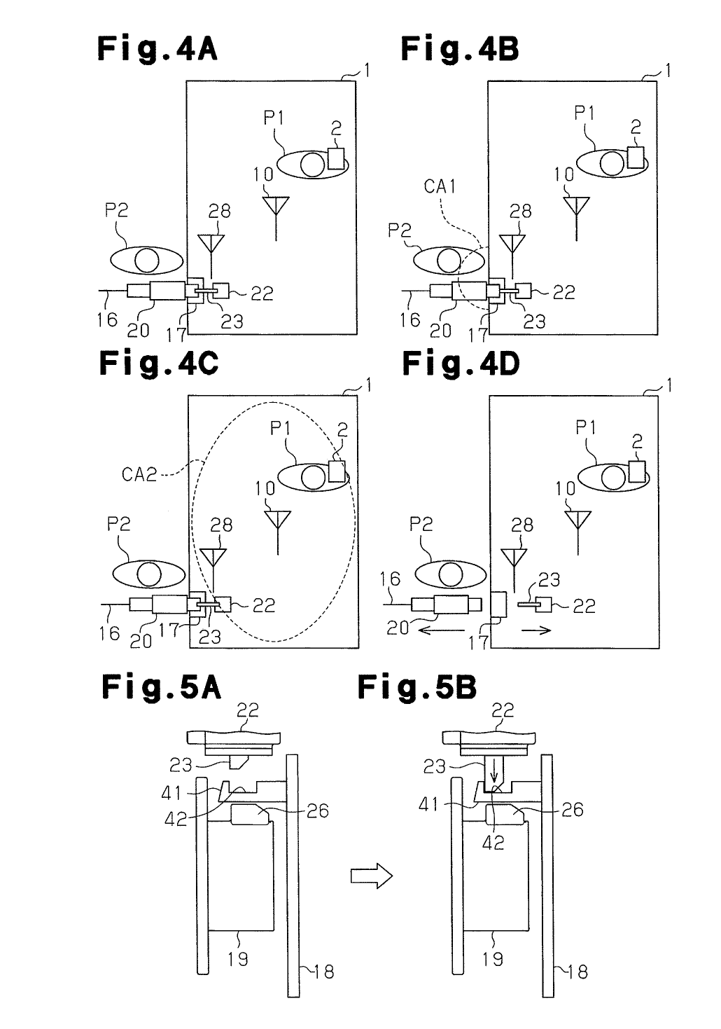

The operation of the lock device 22 when unlocking the charge cable 16 will now be described with reference to FIGS. 4A to 4D.

FIG. 4A shows an example in which the charge cable 16 is locked, and the person P1 carrying the electronic key 2, who may be the driver, is inside the vehicle 1. Further, a person P2, who is not carrying the electronic key 2 and who may be a passenger, is outside the vehicle 1. Here, the verification request unit 31 does not detect an unlocking initiation event, and the transmission antenna 28 does not transmit a request signal Srq to the verification power port communication area CA1.

Referring to FIG. 4B, the person P2 not carrying the electronic key 2 then operates the unlocking operation unit 27. Here, the verification request unit 31 detects an unlocking request event and provides the verification ECU 4 with a smart verification initiation request. The verification ECU 4 transmits a request signal Srq from the transmission antenna 28 to the exterior power port communication area CA1 and executes smart verification in the exterior power port communication area CA1. The person P2 near the power port 17 is not carrying the electronic key 2. Thus, smart verification is not accomplished in the exterior power port communication area CA1.

Referring to FIG. 4C, after transmitting the request signal Srq from the transmission antenna 28, when the verification ECU 4 recognizes that smart verification has not been accomplished in the exterior power port communication area CA1 within a predetermined time, the verification ECU 4 then transmits a request signal Srq from the interior transmitter 10 to a vehicle interior communication area CA2 inside the vehicle 1. In this case, the person P1 carrying the electronic key 2 is inside the vehicle 1. Thus, smart verification is accomplished in the vehicle interior communication area CA2. When smart verification is accomplished in the vehicle interior communication area CA2, the verification ECU 4 provides the lock ECU 29 with a smart verification accomplishment notification. The verification result acquisition unit 32 acquires the smart verification accomplishment notification.

Referring to FIG. 4D, when the lock control unit 33 detects the unlocking request event and then receives the smart verification accomplishment notification, the lock control unit 33 provides the actuator 30 with an unlock drive signal and moves the lock pin 23 from the lock position to the unlock position. This disengages the lock pin 23 from the charge cable 16 and unlocks the charge cable 16 so that the charge cable 16 is removable from the inlet 19.

In the illustrated example, the unlocking request event is an operation performed on the unlocking operation unit 27, which is arranged in the power port 17. However, the unlocking request event is not limited. For example, an unlocking request event may be the unlocking of the vehicle door when the charge cable 16 is connected to the inlet 19. The unlocking operation unit 27 may be arranged at a location other than the power port 17. In some embodiments, the unlocking operation unit 27 is arranged inside the vehicle 1.

The above embodiment has the advantages described below.

(1) When the lock ECU 29 detects an operation performed on the unlocking operation unit 27, the lock ECU 29 executes vehicle interior smart verification. Accordingly, when the person P1 carrying the electronic key 2 is inside the vehicle 1, the person P2 outside the vehicle 1 who is not carrying the electronic key 2, such as a passenger or an attendant at a charging stand, is able to remove the charge cable 16 from the inlet 19. For example, when the person P2 not carrying the electronic key 2 operates the unlocking operation unit 27, vehicle exterior smart verification and, subsequently, vehicle interior smart verification are executed. Smart verification is accomplished on the electronic key 2 located in the vehicle 1, and the charge cable 16 is unlocked. In this manner, as long as the person P1 holding the electronic key 2 is inside the vehicle 1, the person P2 outside the vehicle 1 who is not carrying the electronic key 2, such as a passenger or an attendant, is able to remove the charge cable 16 from the inlet 19. Thus, when the charge cable 16 is removed from the inlet 19, the person P1 carrying the electronic key 2 does not have to go outside the vehicle 1 to accomplish smart verification in the exterior power port communication area CA1. This improves the convenience of the lock device 22.

(2) The wireless communication of the electronic key 2 includes smart verification executed in the vehicle interior communication area CA2. When the person P1 holding the electronic key 2 is inside the vehicle 1, the person P2 who is not carrying the electronic key 2, such as a passenger or an attendant, is able to remove the charge cable 16 from the inlet 19. This improves the convenience of the lock device 22.

(3) The wireless verification of the electronic key 2 includes smart verification that is executed in the vehicle interior communication area CA2 and smart verification that is executed in the exterior power port communication area CA1. Thus, even when the electronic key 2 is not located in the vehicle 1 and located near the power port 17, smart verification is accomplished on the electronic key 2. For example, the person P1 carrying the electronic key 2 outside the vehicle 1 may remove the charge cable 16 from the inlet 19. Thus, the charge cable 16 may be unlocked regardless of whether the electronic key 2 is located inside the vehicle 1 or near the power port 17.

(4) When the unlocking operation unit 27 is manually operated under a situation in which the charge cable 16 is locked, smart verification is first executed in the exterior power port communication area CA1. When smart verification is not accomplished, smart verification is executed in the vehicle interior communication area CA2. When smart verification is accomplished in the exterior power port communication area CA1, vehicle interior smart verification is not executed. For example, when the electronic key 2 is located near the power port 17, vehicle interior smart verification is not executed. In this manner, vehicle interior smart verification is executed only when necessary, and unnecessary executions of the vehicle interior smart verification are eliminated or reduced.

(5) The lock device 22 is configured to lock the charge cable 16 that serves as a locking subject. This, at least, improves the convenience for locking the charge cable 16.

(6) Vehicle interior smart verification is executed to lock the charge cable 16 with the lock device 22. When the person P1 carrying the electronic key 2 is inside the vehicle 1, vehicle interior smart verification is accomplished. This allows for the lock device 22 to lock the charge cable 16.

It should be apparent to those skilled in the art that the present invention may be embodied in many other specific forms without departing from the spirit or scope of the invention. Particularly, it should be understood that the present invention may be embodied in the following forms.

In addition to the unlocking operation unit 27, a locking unit may be arranged in the power port 17. Alternately, the unlocking operation unit 27 may be used as a common switch shared for a locking operation and an unlocking operation. In this case, whenever the common switch is operated, a locking operation and an unlocking operation may be alternately performed.

The lock ECU 29 may detect the connection of the charge cable 16 from a switch arranged on the charge cable 16.

Vehicle interior smart verification may be executed when only a lock initiation event is detected, only an unlock initiation event is detected, or when both events are detected.

In the above embodiment, smart verification is executed in the power port communication area CA1 before smart verification is performed in the vehicle interior communication area CA2. However, the two smart verifications may be simultaneously executed.

In lieu of or in addition to the smart verification in the exterior power port communication area CA1, smart verification may be executed, for example, in an exterior door communication area formed outside the vehicle 1 by a transmission antenna arranged in the vehicle door.

Instead of an operation-free key system or a wireless key system, the electronic key system 3 may be, for example, a near-field wireless communication system. A near field wireless communication system executes verification through bidirectional near field wireless communication (communication distance of several centimeters to several tens of centimeters) and may be, for example, an immobilizer system or a near field communication (NFC) system.

The electronic key system 3 may use radio waves in frequencies other than the LF band and the UHF band.

The actuator of the lock device 22 is not particularly limited and may be, for example, a motor or a solenoid.

The lock device 22 may manually perform one of a locking operation and an unlocking operation and automatically perform the other one of the locking operation and the unlocking operation.

In each of the above embodiments, as long as the lock pin 23 moves to the lock position and the unlock position, the lock device 22 may have any structure. For example, the lock pin 23 may be a pivotal cylindrical lock member including a cutout portion. In this case, the cutout portion of the lock member allows for operation of the lock arm 24, and the outer surface of the lock member where the cutout portion is not formed restricts movement of the lock arm 24. In another example, the lock member is a pivotal triangular plate.

An urging member may constantly urge the lock pin 23 to the unlock position. As another example, an urging member may constantly urge the lock pin 23 to the lock position.

The movement of the lock pin 23 may be guided by a projection and a groove. The groove may have an inclined bottom surface. In this case, movement of the lock pin 23 along the groove varies the projection amount of the lock pin 23. The lock position and the unlock position correspond to, for example, a location where the projection amount is relatively large and a location where the projection amount is relatively small.

The lock pin 23 may be directly hooked to the outer surface (housing) of the power plug 20.

As shown in FIGS. 5A and 5B, the lock device 22 may lock the lid 18. For example, the lock pin 23 may be engaged with a striker 41 (groove 42), which is arranged on the rear surface of the lid 18, to lock the lid 18 in a closed state.

The lid 18 may be unlocked by operating, for example, a predetermined lid opening button (switch) arranged in the vehicle 1. Alternately, when the electronic key system 3 accomplishes ID verification, the lid 18 may be pushed further inward from a closed position to unlock the lid 18.

After determining that the lid 18 is closed, the lock control unit 33 may lock the lid 18 in cooperation with the locking of the vehicle door. The lock control unit 33 may check whether the electronic key system 3 has accomplished ID verification before locking the lid 18.

The lock device 22 may be configured to lock the charge cable 16 when the charge cable 16 is connected to the inlet 19, and lock the lid 18 when the charge cable 16 is not connected to the inlet 19. Preferably, in this case, the charge cable and the lid 18 are locked by the same lock pin 23 and actuator 30.

The locking subject is not limited to a charge cable 16 and the lid 18, and may be any component related with the power port 17 of a battery-powered vehicle.

The lock device 22 may be a combination of a charge cable lock device and a lid lock device.

The lock control unit 33 may control only locking or only unlocking. If the power port 17 does not include the unlocking operation unit 27, the execution of smart verification in the exterior power port communication area CA1 may be omitted.

In some embodiments, the lock ECU 29 may solely function as a controller or be integrated with the verification ECU 4 to function as a controller. The controller includes computer-readable instructions to be executed by the controller. In some embodiments, the instructions may be stored in a computer-readable storage device, such as a magnetic disk or an optical disc, coupled to, accessed by, or included in the controller.

The above description is intended to be illustrative, and not restrictive. For example, the above-described examples (or one or more aspects thereof) may be used in combination with each other. Inventive subject matter may lie in less than all features of a particular disclosed embodiment and may be modified within the scope and equivalence of the appended claims.

1. A lock device that locks a locking subject to restrict removal of a charge cable from a power port of a vehicle or restrict access of the charge cable to the power port, the lock device comprising:
a verification request unit that requests for wireless communication verification including vehicle interior verification to be executed on an electronic key when the verification request unit detects an event that initiates the wireless communication verification; and
a control unit that controls at least one of locking and unlocking of the locking subject based on a result of the wireless communication verification.

2. The lock device according to claim 1, wherein the verification request unit requests for execution of the wireless communication verification including the vehicle interior verification when detecting an unlocking initiation event that is an operation for unlocking the locking subject.

3. The locking device according to claim 1, wherein
the verification request unit requests for execution of the wireless communication verification that includes the vehicle interior verification and vehicle exterior verification, and
the vehicle exterior verification is executed in an exterior power port communication area formed around the power port.

4. The lock device according to claim 3, wherein
the request for execution of the wireless communication verification from the verification request unit is configured to:
execute the vehicle exterior verification and check whether or not the electronic key is located in the exterior power port communication area, and
if the vehicle exterior verification is unaccomplished, execute the vehicle interior verification to check whether or not the electronic key is located inside the vehicle in an interior communication area.

5. The lock device according to claim 1, wherein the locking subject includes a charge cable.

6. A lock device controller that controls a movable lock member for locking a locking subject to restrict removal of a charge cable from a power port of a vehicle or restrict access of the charge cable to the power port, wherein the movable lock member is movable between a lock position where the lock member locks the locking subject and an unlock position where the lock member unlocks the locking subject, the lock device controller comprising:
a verification request unit that requests for wireless communication verification including vehicle interior verification to be executed on an electronic key when detecting an event that initiates locking or unlocking of the locking subject; and
a control unit that controls the movement of the movable lock member based on a result of the wireless communication verification.

7. An electronic key system comprising:
an electronic key that performs wireless communication;
a verification ECU that performs wireless communication verification on the electronic key; and
a lock device that locks a locking subject to restrict removal of a charge cable from a power port of a vehicle or restrict access of the charge cable to the power port, wherein the lock device includes
a movable lock member that is movable between a lock position where the lock member locks the locking subject and an unlock position where the lock member unlocks the locking subject,
an event sensor that detects an event for requesting the locking subject to be unlocked, and
a controller that receives a detection result from the event sensor and controls the movement of the movable lock member, wherein the controller is configured to:
request the verification ECU to execute wireless communication verification including vehicle interior verification on the electronic key when the event sensor detects the event, and
move the movable lock member to the unlock position when the vehicle interior verification, which is executed after the event is detected, is accomplished.

8. The electronic key system according to claim 7, wherein the verification ECU is configured to
first execute, when receiving the request for execution of the wireless communication verification, vehicle exterior verification in an exterior power port communication area formed around the power port, and
then execute the vehicle interior verification in the vehicle if the vehicle exterior verification is unaccomplished.
